(19) United States
(12) Patent Application Publication
(10) Pub. No.: US 2016/0055407 A1
(43) Pub. Date: Feb. 25, 2016

(54) RFID TAG SHEET, INFORMATION INPUT SYSTEM, STORAGE OBJECT, AND INFORMATION REPRESENTING MEDIUM

(71) Applicant: HITACHI SYSTEMS, LTD., Tokyo (JP)

(72) Inventors: Shigeru Yamagata, Shinagawa-ku, Tokyo (JP); Shigeru Yamauchi, Shinagawa-ku, Tokyo (JP); Tsuyoshi Miyazaki, Shinagawa-ku, Tokyo (JP); Kenichiro Tomoi, Shinagawa-ku, Tokyo (JP)

(21) Appl. No.: 14/781,376

(22) PCT Filed: Apr. 2, 2013
(86) PCT No.: PCT/JP2013/060076

§ 371 Date: Sep. 30, 2015

(51) Int. Cl. G06K 19/073; G06K 19/077

(52) U.S. Cl. CPC G06K 19/07327; G06K 19/0772

(57) ABSTRACT

The present invention is an RFID tag sheet to which information can be inputted by simple operations and configurations by using a sheet, card, or others in which a plurality of RFID tags are embedded without requirement for rewriting the contents of RFID tags and updating corresponding data. A typical embodiment of the present invention has a shielding member attached detachably to a surface of an RFID tag sheet made of a sheet-shaped electric wave transmitting material in which a plurality of RFID tags are embedded so that all or some of the RFID tags are covered, and the shielding member is made of a material that shields electromagnetic waves used in communication between the RFID tag and a reader device.

### CROSS REFERENCE TO RELATED APPLICATIONS

This application is entitled to the benefit of and incorporates by reference subject matter disclosed in International Patent Application No. PCT/JP2013/060076 filed on Apr. 2, 2013.

### TECHNICAL FIELD

The present invention relates to a technique of input and display of information, and more particularly the present invention relates to a technique effectively applied to an RFID tag sheet, an information input system, a storage object, and an information representing medium which perform the input and the display by using a plurality of RFID (Radio Frequency IDentification) tags.

### BACKGROUND ART

For example, in process management or others at a production site, in order to enable a person in charge of each process to easily understand a progress of each process, to make an instruction to a production machine or others, and to input information of the number of defects or others, a method is known, the method performing inputs by using a process management card or others in which an RFID tag capable of identifying the information is embedded and causing a reader device to read the card.

For example, Japanese Patent Application Laid-Open Publication No. 2004-295401 and “What is RECO-View (registered tradename)”, [online], Ricoh Company Ltd., [searched on February 27, Heisei 25], Internet URL:http://www.ricoh.co.jp/thermal/recoview/about/describe an information recording medium having an IC region which stores process management information for each of predetermined processes, and a rewrite region which displays the stored process management information as visible information so as to be rewritable, the information recording medium can access a rewritable device used for rewriting the visible information corresponded to each process and displayed in a rewritable region via communication means, has process selecting means, process-management-information reading means, and rewrite instructing means, and instructs the rewritable device to select the process corresponding to the accessed rewritable device from an IC region, to read the process management information corresponding to the selected process, and to rewrite the rewrite region based on the process management information.

### SUMMARY

In the conventional technique as described in Japanese Patent Application Laid-Open Publication No. 2004-295401, the process management information can be inputted by rewriting the display of the card for each process in addition to the contents of the RFID tag of the card or others, and reading the information.

However, in order to, for example, rewrite a memory of the RFID tag, such a system adversely requires a reader/writer device having a writing function or requires a process such as update of data corresponding to ID information of the RFID tag on a database. Even when minor information such as input of the number of defectives of a lot is desired to be inputted, the requirement of, for example, the rewriting by using the reader/writer device, the input by using an input device such as a keyboard or a touch panel, or others may be excessive load to an input operator.

Accordingly, an object of the present invention is to provide an RFID tag sheet, an information input system, a storage object, and an information representing medium which enable input of information by simple operations and configurations using a sheet, a card, or others in which a plurality of RFID tags are embedded without the rewriting of the content of the RFID tag and the update of the corresponding data.

The above and other object and novel characteristics of the present invention will be apparent from the description of the present specification and the accompanying drawings.

The typical summary of the inventions disclosed in the present application will be briefly described as follows.

An RFID tag sheet according to a typical embodiment of the present invention is an RFID tag sheet made of a sheet-type electric wave transmitting material in which a plurality of RFID tags are mounted, the RFID tag sheet has: a shielding member detachably attached to a surface of the RFID tag sheet so that all or some of the RFID tags are covered, and the shielding member is made of a material shielding electromagnetic waves used in communication between the RFID tag and the reader device.

Also, the present invention can be also applied to an information input system, a storage object, and an information representing medium using the above-described RFID tag sheet.

The effects obtained by typical aspects of the invention disclosed in the present application will be briefly described below.

That is, according to the typical embodiment of the present invention, information can be inputted by simple operations and configurations using a sheet, a card, or others in which the RFID tags are mounted without the rewriting of the content of the RFID tag and the update of corresponding data.

### BRIEF DESCRIPTIONS OF THE DRAWINGS

FIG. 1 is a perspective view showing an outline of a configuration example of an RFID tag sheet according to an embodiment of the present invention;

FIG. 2 is a cross-sectional view showing an outline of the configuration example of the RFID tag sheet according to the embodiment of the present invention;

FIG. 3 is a diagram showing an outline of an example of a casein which the RFID tag sheet of the embodiment of the present invention is read by a reader device;

FIG. 4 is a diagram showing an outline of an example of a case in which the information identified by each RFID tag in the embodiment of the present invention is previously shown;

FIG. 5 is a flowchart showing an outline of an example of a process flow of a case in which the RFID tag sheet in the embodiment of the present invention is used in input of management information in process management at a production site; and

FIG. 6 is a flowchart showing an outline of an example of a process flow of specification of a product/lot and input of the number of defectives in the embodiment of the present invention.

### DETAILED DESCRIPTION

Hereinafter, embodiments of the present invention will be described in detail with reference to the accompanying drawings. Note that the same components are denoted by the same reference symbols throughout all the drawings for describing the embodiments, and the repetitive description thereof will be omitted.

An RFID tag sheet according to an embodiment of the present invention is an object such as a sheet or a card (hereinafter, they are collectively simply referred to as “sheet” in some cases) in which a plurality of RFID tags containing information recorded so that different pieces of predetermined information from each other can be identified are arranged and embedded, and in which the surface of the sheet corresponding to each of the embedded parts is shielded by a sticker or others so that each RFID tag cannot be read by a reader device.

For example, if minor and uncertain information such as the number of defectives of a lot in process management as described above is to be inputted by using the RFID tag sheet, the sticker or others for shielding the part with the RFID tag embedded therein capable of identifying the information of an input target is peeled off, and then, the RFID tag sheet is read by the reader device. In this manner, only the information identified by the unshielded RFID tag can be read by the reader device and used as the input information.

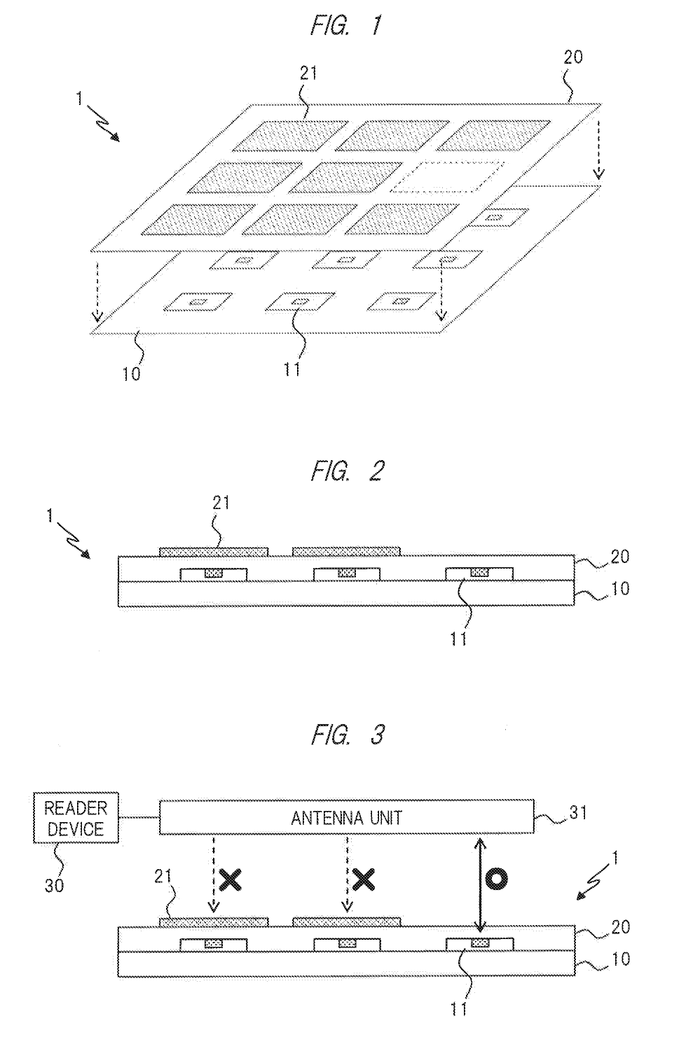

FIG. 1 and FIG. 2 are a perspective view and a cross-sectional view showing outlines of a configuration example of an RFID tag sheet according to an embodiment of the present invention. The RFID tag sheet 1 is formed by joining a base sheet 10 which is made of an electric wave transmitting material (such as an acrylic sheet) such as resin, paper, or wood, and a protective sheet 20 which is similarly made of an electric wave transmitting material (such as a polyester film). The RFID tags 11 are sealed between the base sheet 10 and the protective sheet 20 by arranging the plurality of RFID tags 11 on the base sheet 10 so as not to be overlapped with each other, and joining the protective sheet 20 onto the RFID tags 11. The RFID tags 11 are, for example, a passive type that supports a SHF (Super High Frequency) bandwidth, a UHF (Ultra High Frequency) bandwidth, and a HF (High Frequency) bandwidth.

In the present embodiment, note that, although the RFID tags 11 are embedded by joining the base sheet 10 and the protective sheet 20, a method of forming the RFID tag sheet 1 is not limited thereto. For example, it may be formed by sandwiching the RFID tags 11 by one sheet by folding the sheet, or it may be formed as integral formation.

In the present embodiment, furthermore, at a position on the protective sheet 20 corresponding to a position at which the RFID tags 11 on the base sheet 10 are arranged, a shielding sticker 21 is bonded so as to be freely peel off in a state of covering and shielding each RFID tag 11 when viewed from the surface side of the protective sheet 20. For example, a state in which the shielding sticker 21 is peeled off is shown at the position in FIG. 1 shown by a dotted line on the protective sheet 20 and at the position in FIG. 2 corresponding to the right RFID tag 11.

The shielding sticker 21 is formed by, for example, applying a bonding agent, an adhesive agent, or others to a material such as aluminum which shields SHF waves, UHF waves, and HF waves. The RFID tag sheet 1 may be configured to be reusable by, for example, attaching the peeled-off shielding sticker 21 again so as to be detachable by using a bonding agent, etc., and a joining member such as a hook-and-loop fastener which can be repeatedly peeled off and pasted. Note that the shielding sticker 21 has such a size and a shape that can cover the entirety of the RFID tags 11.

FIG. 3 is a diagram showing an outline of an example of a case in which the RFID tag sheet 1 is read by the reader device. Here, the RFID tag sheet 1 is shown by the cross-sectional view of the example of FIG. 2. The information of each RFID tag 11 embedded in the RFID tag sheet 1 is read by the reader device 30 by holding an antenna unit 31 of a reader device 30 over the surface side of the RFID tag sheet 1, in other words, over the side thereof on which the shielding sticker 21 is pasted, or by holding the surface side of the RFID tag sheet 1 over the antenna unit 31.

Here, the RFID tags 11 (the two on the left side in the diagram) shielded by the shielding stickers 21 are shown so that the communication between the reader device 30 and the RFID tags 11 is not established because the communication SHF waves, UHF waves, and HF waves outputted from the antenna unit 31 are shielded by the shielding stickers 21. Therefore, the reader device 30 cannot recognize the RFID tags 11 (cannot read the information). On the other hand, the RFID tag 11 (the one on the right side in the diagram) which is not shielded by the shielding sticker 21 is shown so that the communication with the reader device 30 is established, and the information can be read.

As shown in the example of FIG. 3, the present embodiment obtains such a shielding effect as preventing the communication between the reader device 30 and the RFID tags 11 from being established by sealing the RFID tags 11 arranged on the base sheet 10 by using the protective sheet 20 and covering the surfaces thereof by the shielding stickers 21, and the antenna units of the RFID tags 11 and the shielding stickers 21 can sufficiently come close to each other by pasting the shielding stickers 21, which results in the short circuit effect, and therefore, the shielding effect can be further improved.

In the present embodiment, for each RFID tag 11 embedded in the RFID tag sheet 1, information (for example, a number, a character, a symbol, etc.) which becomes a candidate of the input target is previously set so as to be identifiable. In this manner, the information desired to be inputted can be inputted by peeling off the shielding sticker 21 pasted on a position corresponding to the position of the RFID tag 11 containing the information desired to be inputted so as to be identifiable, and then, reading the RFID tag sheet 1 by the reader device 30. Each piece of the information to be the candidate of the input target may be, for example, directly written to each of the RFID tags 11 or may be set in a database or others on a not-shown server in association with ID information of each of the RFID tags 11.

Here, the information (information of the input target) identified by the RFID tags 11 is retained in the RFID tags 11 or a server, and therefore, cannot be visually checked in this state. For example, in the technique described in Japanese Patent Application Laid-Open Publication No. 2004-295401, a medium in which an RFID tag is embedded has display means formed of an electronic paper, and the information identified by the RFID tag is visualized by also rewriting the contents to be displayed on a display unit as the value indicating the information when the information identified by the RFID tag is rewritten by a reader/writer device. However, in a case of such a method, means for rewriting both of the information identified by the RFID tag and the display contents of the electronic paper are adversely required.

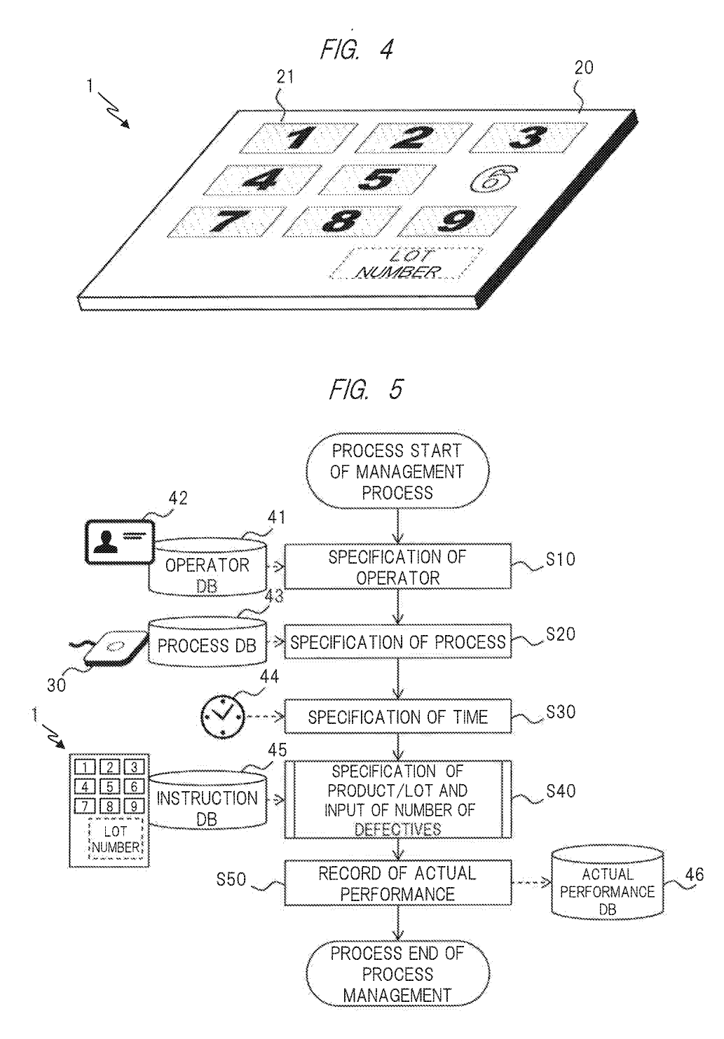

On the other hand, in the present embodiment, the information identified by the plurality of RFID tags 11 embedded in the RFID tag sheet 1 is visualized by previously printing the information or others to be displayed on the corresponding positions on the RFID tag sheet 1, respectively. FIG. 4 is a diagram showing an outline of an example of the case in which the information identified by the RFID tags 11 is previously displayed. As shown in the example of FIG. 4, in the RFID tag sheet 1, the information (for example, integers “1” to “9” in the example of FIG. 4) identified by the RFID tags 11 at the corresponding positions is previously printed or others to be displayed on the surfaces of the shielding stickers 21. In this manner, a user can visually easily recognize the information which can be inputted by the RFID tag sheet 1.

Moreover, also on the protective sheet 20 at apart on which each shielding sticker 21 is pasted, the same information as the information displayed by the shielding sticker 21 is previously printed or others to be displayed. In this manner, even if the shielding sticker 21 is peeled off in order to input the information, it is possible to visually easily recognize which information (“6” in the example of FIG. 4) has been the input target (which shielding sticker 21 has been peeled off). Moreover, information having different contents can be appropriately inputted without the rewriting of the contents of the RFID tags 11 and the display on the RFID tag sheet 1, in other words, without the means for the rewriting such as a device.

In the example of FIG. 4, note that the nine shielding stickers 21 (and the corresponding RFID tags 11) are arranged in three rows and three columns in order to input the integers “1” to “9”. However, the arrangement number, the arrangement positions, etc. are not limited thereto. Moreover, also for the information of the input target (the information displayed on the shielding stickers 21 and the protective sheet 20), various types such as a character, a symbol, a text, a figure, and a picture image other than a number can be appropriately used depending on a usage environment.

Meanwhile, in the example of FIG. 4, a state in which the shielding sticker 21 on which “6” is displayed is peeled off when “6” is desired to be inputted is shown. However, the RFID tags 11 of the passive type are used and therefore have characteristics that the plurality of RFID tags 11 can be simultaneously read by the reader device 30. Therefore, the plurality of shielding stickers 21 can be peeled off and used as the input targets. In this case, input data may be determined by the combination of the information identified by the RFID tags 11 from which the shielding stickers 21 have been peeled off. Alternatively, for example, if the information of the input target is number, the largest one among pieces of the information (numbers) identified by the respective RFID tags 11 from which the shielding stickers 21 have been peeled off may be determined as the input data.

As an occasion to use the RFID tag sheet 1 of the present embodiment, for example, it is conceivable to use it for managing/recognizing each process in a process management work at a production site. In the process management work, a process management system which uses RFID tags in order to acquire various types of management information is used in some cases. In such a system, generally, additional information such as an operator, a product, a lot number, a process, time, and the number of defects in each process is acquired by reading, by a reader device, a process management card, a sales slip, etc. in which the RFID tag capable of identifying the management information is embedded.

In the present embodiment, as a case of usage of the RFID tag sheet 1 in the process management work, for example, as shown in the example of FIG. 4, an RFID tag 11 in which the information capable of identifying a lot number is set is embedded in a part displayed as “lot number” at a lowermost part in addition to the arrangement of the RFID tags 11 corresponding to the integers “1” to “9” for inputting a number such as the number of defectives. The lot number is fixed information, and therefore, is not required to be shielded particularly by the shielding sticker 21.

FIG. 5 is a flowchart showing an outline of an example of a process in a case of usage of the RFID tag sheet 1 of the present embodiment for the input of the management information in the process management at the production site. Here, as described above, for example, a case of input by the usage of the RFID tag sheet 1 of the present embodiment when minor and variable information such as the number of defectives of a lot is inputted is described.

In process management process of each process, first, the information of the operator is specified (S10). Here, for example, a process management system serving as an information input system for process management acquires information of an IC card 42 such as an ID card or an admission pass held by the operator and the information of an RFID tag(s) embedded therein by causing the reader device 30 or others to read the information. Furthermore, based on the acquired ID information, etc., a database (operator DB 41) which retains the information of the operator is referenced to perform authentication processing, and the information that specifies the operator is acquired.

Next, the information of the process is specified (S20). Here, for example, from the reader device 30, the process management system acquires information such as a control number, identification number, and/or device number of the reader device 30 at the production site. Furthermore, based on the acquired control number, etc., the information specifying the process is acquired by referencing a database (process DB 43) or others which retains the information of the process. Furthermore, information of the time is acquired and specified from a system clock 44 or others (S30).

Then, the operator specifies a product, lot, etc. of the management targets and inputs the information of the number of defects in the process (S40). Here, as described above, the input is performed by simple processing by using the RFID tag sheet 1 of the present embodiment, which is mounted as a production instruction card, a process management card, or others. The processing contents of step S40 will be described later.

Then, the information such as the operator, the product, the lot number, the process, the time, the number of defectives, etc. acquired in steps S10 to S40 is recorded and accumulated in a database (actual-performance DB 46), which records the information of actual-performances of production processes (S50), and then, the process management processing of the process is terminated.

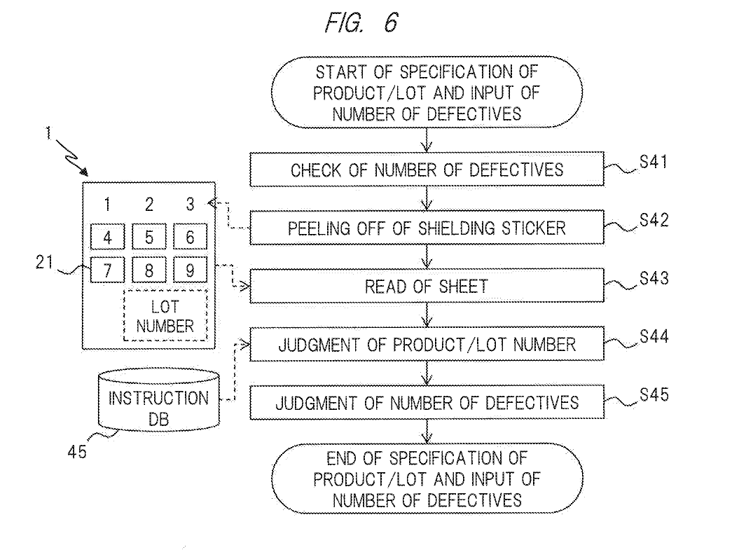

FIG. 6 is a flowchart showing an outline of an example of the process flow of specifying the product/lot and inputting the number of defects in the process management work (S40). In the processing of specifying the product/lot and inputting the number of defects, first, the operator checks and recognizes the number of defects of the lot by visual check or others (S41). Next, the operator peels off the shielding sticker 21 which shows the number corresponding to the checked number of defects, on the RFID tag sheet 1, which is, for example, attached to the product itself or mounted as a production instruction card, a process management card, or others (S42).

In the case of the RFID tag sheet 1 for inputting the number as shown in the example of FIG. 4, the shielding sticker 21 corresponding to the finally-checked number of defects (for example, “3”) may be directly peeled off, or the shielding stickers 21 may be sequentially peeled off in the order from “1” every time a defective product is found. The example of the RFID tag sheet 1 shown on the left side of FIG. 6 shows, for example, a case of the peel off of the shielding stickers 21 sequentially from “1” to “3”.

Next, the RFID tag sheet 1 in the state in which the shielding sticker 21 has been peeled off is read by the reader device 30 (S43). Here, as described above, in addition to the contents of the one or more RFID tag (s) 11 from which the shielding sticker 21 has peeled off and in which the reading is possible, the process management system collectively reads the contents of the RFID tag 11 at which the information capable of identifying a lot number is set such as the RFID tag 11 at the part of “lot number” by the reader device 30, and then, acquires the information identified by each RFID tag 11 from a memory on the RFID tag 11, a database on a server, or others.

Next, the information of the target product and lot is specified (S44). As needed, based on the information of the lot number, etc. read in step S43, information specifying the product and the lot is acquired by referencing, for example, a database (instruction DB 45) or others retaining information such as the production instruction including the information of the product, lot, etc.

The largest one among the values which have been read in step S43 and can be identified by the RFID tags 11 at the parts from which the shielding stickers 21 have been peeled off (“3” in the example of the RFID tag sheet 1 shown on the left side of FIG. 6) is determined, and is set as the number of defects (S45), and the defective-number input processing is terminated. The obtained information of the number of defects is recorded in the actual-performance DB 47 together with other process management information in step S60 of FIG. 5.

As described above, note that the RFID tag sheet 1 from which the shielding sticker(s) 21 have been peeled off in order to input the number of defectives can be reused by pasting the peeled-off shielding sticker(s) 21 again to the corresponding position(s). Also, the RFID tag sheet may be reused by detaching the entire protective sheet 20 by peel-off or others and replacing it by attaching a new protective sheet 20, on which all the shielding stickers 21 are pasted, by bonding or others.

As explained above, in the RFID tag sheet 1 according to an embodiment of the present invention, for example, the plurality of RFID tags 11 in which information is recorded so that different pieces of the predetermined information from each other can be identified are arranged and embedded in a sheet-shaped object, and each surface of the sheet corresponding to the embedded part is shielded by the shielding sticker 21, so that each RFID tag 11 cannot be read by the reader device 30.

When information is inputted by the RFID tag sheet 1, only the information identified by the unshielded RFID tag(s) 11 is read by the reader device 30 and set as the input information by a simple operation of peeling off the shielding sticker(s) 21 corresponding to the RFID tag(s) 11 capable of identifying the information of the input target(s), and then, causing the reader device 30 to read the RFID tag sheet 1. Moreover, the RFID tag sheet 1 can be easily reused by, for example, pasting the peeled-off shielding sticker(s) 21 again. In other words, the information of the input target can be appropriately changed by peeling-off/pasting the shielding stickers 21.

Also, the information which can be identified by the RFID tags 11 (the information of the input targets) is displayed by previously printing or others on the corresponding shielding stickers 21 and/or on the corresponding parts of the protective sheet 20, so that the information of the input targets or the contents of the information represented by the RFID tag sheet 1 can be easily visualized even when being changed. Moreover, a system configuration can be also simplified because the means for rewriting or changing the information identified by each RFID tag 11 is not required.

In the foregoing, the invention made by the present inventors has been concretely described based on the embodiments. However, it is needless to say that the present invention is not limited to the foregoing embodiments and various modifications and alterations can be made within the scope of the present invention. For example, the above-described embodiments have been explained in detail for easily understanding the present invention, but are not always limited to the ones including all structures explained above. Further, the other structure can be added to/eliminated from/replaced with a part of the structure of the above-described embodiments.

For example, in the above-described embodiments, the process management card formed of the RFID tag sheet 1 is used for inputting the number of defectives of the product in the process management system. However, this is not limited thereto. For example, in a stock management system, the RFID tag sheet 1 is attached to a storage object such as a rack or a container for storing parts or others therein, and the shielding stickers 21 are sequentially peeled off by the number of the parts which have been taken out, so that the number of stocks can be easily recognized, and therefore, inventory can be easily carried out without attaching the RFID tag to each parts. In this case, the input information may be acquired based on not the largest one among the numerical values identified by the plurality of RFID tags 11 from which the shielding stickers 21 have been peeled off but the information indicating how many RFID tags 11 have been read (how many shielding stickers 21 have been peeled off).

Also, in the above-described example, instead of attaching the sheet-type RFID tag sheet 1 serving as the information recording medium to the rack or others, the RFID tag is arranged and embedded directly in a planar part of the storage object itself such as the rack or the container, and each RFID tag part is shielded by the shielding sticker, so that a structure similar to the RFID tag sheet 1 of the present embodiment can be directly formed in the rack or the container, and the rack or the container itself can be used as the information recording medium.

Also, the field of application of the invention is not limited to process management, stock management, etc. at the production site. As application thereof to other fields, for example, the RFID tag sheet 1 can be used as a bingo card or others used in a bingo game. In this case, the RFID tags 11 embedded in the respective bingo cards are set so as to be able to identify the information of the different numbers from each other which are previously randomly determined and the information of matrix positions (rows/columns) of the RFID tags 11 on the bingo card, and the numbers set at the corresponding RFID tags 11 are displayed on the corresponding parts of the shielding stickers 21 and the protective sheet 20.

In a game, a drawn number is registered in a system configuring of a PC or others, and a participant peels off the shielding sticker 21 displaying the number if the drawn number exists in the participant's bingo card. In checking the winning, it can be easily judged whether the winner exists or not by the system based on the information of the plurality of identified numbers and positions only by reading the bingo card by the reader device 30.

Also, the information to be the input target which is represented/displayed by the RFID tag sheet 1 is not limited to the numerical-value information. For example, in a case of application of the invention to a quality inspection work, etc., information of inspection results such as “good” or “no good” can be displayed and used as the information target. In a case of application to shipment inspection work, etc. of fruits, etc., size information such as “S”, “M”, and “L” can be displayed and used as the input target. Also, in a case of application of the invention to an entrance ticket, etc., information such as “entered”, “temporarily exited”, and “re-enter” can be displayed and used as the input target depending on changes in the state. That is, the RFID tag sheet 1 of the present embodiment can represent such various types of information, and can be appropriately used for an information representing medium such as a card and a sales slip serving as the input target.

The present invention can be used for an RFID tag sheet, an information input system, a storage object, and an information representing medium, which input and display information by using a plurality of RFID tags.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An RFID tag sheet made of a sheet-shaped electric wave transmitting material in which a plurality of RFID tags are embedded,
wherein the RFID tag sheet has a shielding member detachably attached to a surface of the RFID tag sheet so as to cover all or some of the RFID tags, respectively, and
the shielding member is made of a material shielding electromagnetic waves used in communication between the RFID tag and a reader device.

2. The RFID tag sheet according to claim 1,
wherein the shielding member is formed of a seal-shaped member that can be pasted onto and peeled off from the surface of the RFID tag sheet.

3. The RFID tag sheet according to claim 1,
wherein a content which indicates information identified by the RFID tag covered by the shielding member is displayed on a surface of the shielding member and on a part of the RFID tag sheet to which the shielding member is attached.

4. An information input system that receives input of information by using the RFID tag sheet according to claim 1,
wherein information identified by one or more of the RFID tags from which the shielding member(s) has been peeled off among the RFID tags embedded in the RFID tag sheet is read by the reader device, and
input information is judged based on a content of the read information and/or the number of the read RFID tags.

5. A storage object to which the RFID tag sheet according to claim 1 is attached.

6. A storage object including a part made of an electric wave transmitting material in which a plurality of RFID tags are embedded,
wherein the storage object has a shielding member detachably attached to a surface of the storage object so that all or some of the RFID tags are covered, respectively, and
the shielding member is made of a material shielding electromagnetic waves used in communication between the RFID tag and a reader device.

7. An information representing medium formed of the RFID tag sheet according to claim 1.

8. The RFID tag sheet according to claim 2,
wherein a content which indicates information identified by the RFID tag covered by the shielding member is displayed on a surface of the shielding member and on a part of the RFID tag sheet to which the shielding member is attached.

9. An information input system that receives input of information by using the RFID tag sheet according to claim 2,
wherein information identified by one or more of the RFID tags from which the shielding member(s) has been peeled off among the RFID tags embedded in the RFID tag sheet is read by the reader device, and
input information is judged based on a content of the read information and/or the number of the read RFID tags.

10. A storage object to which the RFID tag sheet according to claim 2 is attached.

11. An information representing medium formed of the RFID tag sheet according to claim 2.
